(19) United States
(12) Patent Application Publication
(10) Pub. No.: US 2011/0128298 A1
(43) Pub. Date: Jun. 2, 2011

(54) DISPLAY SYSTEM, IMAGE PROCESSING APPARATUS, CONTROL METHOD THEREFOR, AND STORAGE MEDIUM

(75) Inventor: Taro Tsuchida, Kawasaki-shi (JP)

(73) Assignee: CANON KABUSHIKI KAISHA, Tokyo (JP)

(21) Appl. No.: 12/952,594

(22) Filed: Nov. 23, 2010

(30) Foreign Application Priority Data
Dec. 2, 2009 (JP) 2009-274370

(51) Int. Cl. G09G 5/00; G06F 3/12

(52) U.S. Cl. 345/619; 358/1.15

(57) ABSTRACT

The present invention provides an image processing apparatus having a function of controlling a display of document data by a projector. The image processing apparatus analyzes a property of the document data, generates display data for displaying the document data by the projector, determines a control command for controlling the projector based on the analyzed property of the document data, and transmits the generated display data and the determined control command to the projector.

### BACKGROUND OF THE INVENTION

1. Field of the Invention

The present invention relates to a display system, an image processing apparatus, a control method therefor, and a storage medium, and in particular, to a technique for displaying document data by a projector.

2. Description of the Related Art

Conventionally, there has been known PJLink established as a standard protocol for remotely controlling a projector via, for example, a network, which can be used in a multivendor environment. This PJLink protocol defines projector control commands for remotely controlling a projector, such as changing a video input terminal and resolution, and enabling the audio and visual (AV) mute function.

For use of these projector control commands, a user, or an application software for remote control has determined in advance control commands for use in control of a projector and timing for transmitting the control commands to the projector. For example, Japanese Patent No. 4016251 discusses a method for controlling an apparatus separately from controlling video by preparing commands for controlling the apparatus separately from video data.

Further, in some cases, document data such as office application data and Portable Document Format (PDF) data are displayed by a projector under control by an image processing apparatus such as a multifunction peripheral, instead of display control by a personal computer. In such a case, document data is converted into bitmap data as display data in advance by an image forming apparatus for each page, and further, for each of various effects such as fade-in. Then, the bitmap data is transmitted from the image processing apparatus to the projector, or is read form a recording medium such as a universal serial bus (USB) memory to be displayed by the projector.

However, conventionally, at the time of conversion of document data into bitmap data, all display pages have been converted into bitmap data of a same size, resulting in an increase in the data size and thereby slow-down of the response speed for a display by the projector.

Further, for document data with a display effect set thereto, bitmap data corresponding to the display effect needs to be generated for each display effect, resulting in a further increase in the data size of bitmap data and thereby significant slow-down of the response speed for a display by the projector.

### SUMMARY OF THE INVENTION

The present invention is directed to an image forming apparatus capable of improving a response speed for a display when document data is displayed by a projector under control thereby.

According to an aspect of the present invention, a display system is configured to display document data by a projector under control by an image processing apparatus. In the display system, the image processing apparatus includes an analysis unit configured to analyze a property of the document data, a generation unit configured to generate display data for displaying the document data by the projector, a determination unit configured to determine a control command for controlling the projector based on the property of the document data analyzed by the analysis unit, and a transmission unit configured to transmit the display data generated by the generation unit and the control command determined by the determination unit to the projector.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 schematically illustrates a configuration of a display system according to first and second exemplary embodiments of the present invention;

FIG. 2 is a block diagram schematically illustrating a hardware configuration of a printing apparatus illustrated in FIG. 1.

FIG. 3 is a block diagram schematically illustrating a hardware configuration of a projector illustrated in FIG. 1.

FIG. 4 illustrates processing modules mounted in the printing apparatus.

FIG. 5 is a flowchart illustrating presentation data generation and transmission processing according to the first exemplary embodiment.

FIG. 6 is a flowchart illustrating document data analysis processing.

FIG. 7 is a flowchart illustrating resolution analysis processing.

FIG. 8 is a flowchart illustrating color processing analysis processing.

FIG. 9 is a flowchart illustrating display effect analysis processing.

FIG. 10 is a flowchart illustrating security analysis processing.

FIG. 11 is a flowchart illustrating presentation data generation processing.

FIG. 12A is a table illustrating an example of a result of document data analysis, and FIG. 12B is a table illustrating correspondence between a control command for the projector and a rendering mode, corresponding to the display setting.

FIG. 13 is a flowchart illustrating processing performed by the projector.

FIG. 14 is a sequence diagram illustrating communication between the printing apparatus and the projector according to the first exemplary embodiment.

FIG. 15 illustrates an example of property of the document data.

FIG. 16 illustrates an example of the presentation data.

FIG. 17 is a flowchart illustrating presentation data generation and transmission processing according to the second exemplary embodiment.

FIG. 18 is a flowchart illustrating page division processing according to the second exemplary embodiment.

FIG. 19 schematically illustrates a configuration of a display system according to a third exemplary embodiment of the present invention.

FIG. 20 is a sequence diagram illustrating communication between the printing apparatus and the projector according to the third exemplary embodiment.

FIG. 21 illustrates a result of acquisition of a command request list and control commands for projectors according to the third exemplary embodiment.

### DESCRIPTION OF THE EMBODIMENTS

Various exemplary embodiments, features, and aspects of the invention will be described in detail below with reference to the drawings.

<System Configuration>

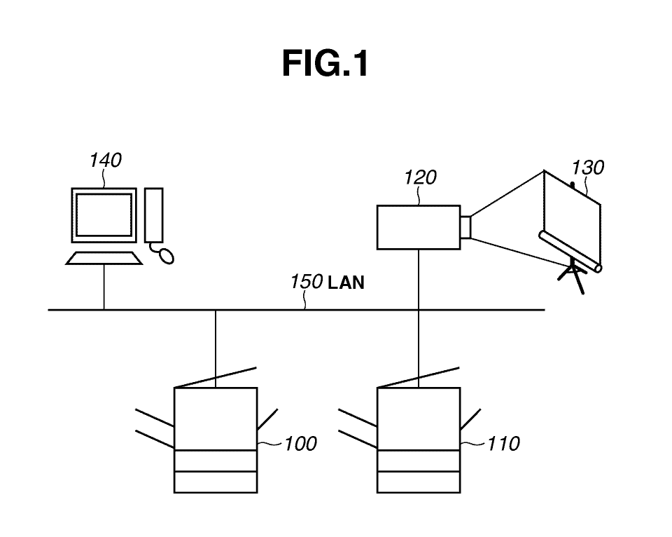

FIG. 1 schematically illustrates a configuration of a display system according to first and second exemplary embodiments of the present invention.

In the present display system, printing apparatuses 100 and 110, a projector 120, and a personal computer (hereinafter abbreviated as “PC”) 140 are connected through a local area network (LAN) 150. The projector 120 enlarges and displays document data supplied from the printing apparatuses 100 and 110 on a screen 130.

The PC 140 can transmit document data to the printing apparatuses 100 and 110 and instruct them to print it via a printer driver. Further, the PC 140 can directly save document data in the format of, for example, PDF (registered trademark) or XML Paper Specification (XPS) (registered trademark) into the printing apparatuses 100 and 110 by using a protocol such as the file transfer protocol (FTP) or the server message block (SMB) protocol.

The printing apparatuses 100 and 110 each are configured as a multifunction peripheral equipped with a plurality of functions such as the scanner function, the print function, and the communication function, and also have the function of converting document data into display data (bitmap data) to display document data with use of the projector 120. In this case, the printing apparatuses 100 and 110 analyze, for example, the resolution of document data, and generate bitmap data of a data size (resolution) according to the analysis result.

<Printing Apparatus>

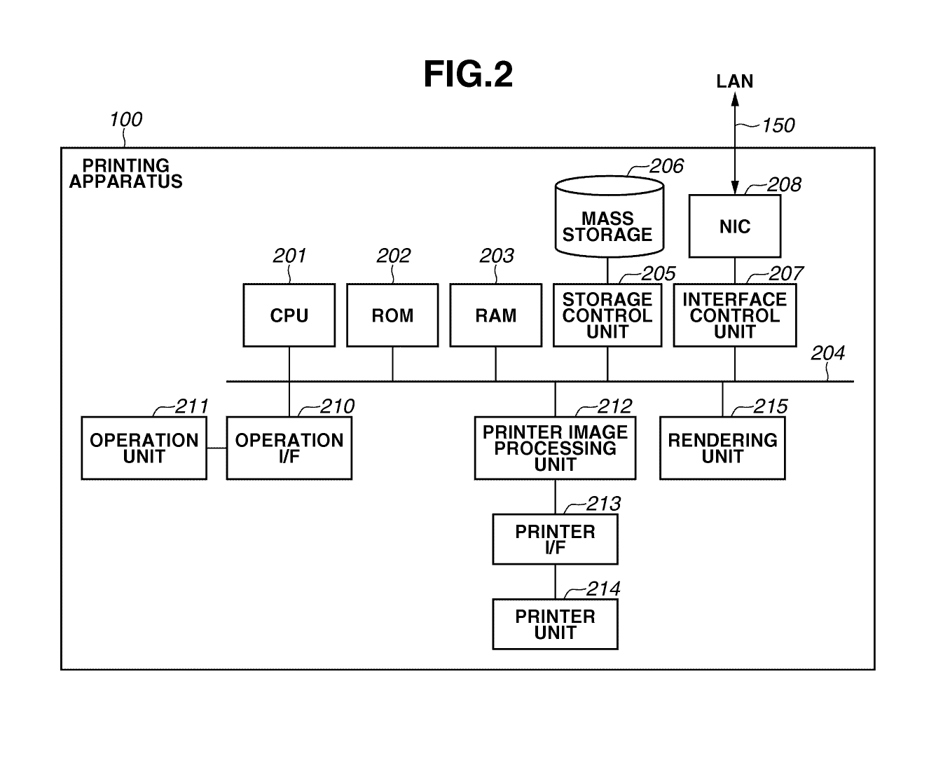

FIG. 2 is a block diagram schematically illustrating a configuration of the printing apparatus 100. The printing apparatus 110 has the same configuration as that of the printing apparatus 100.

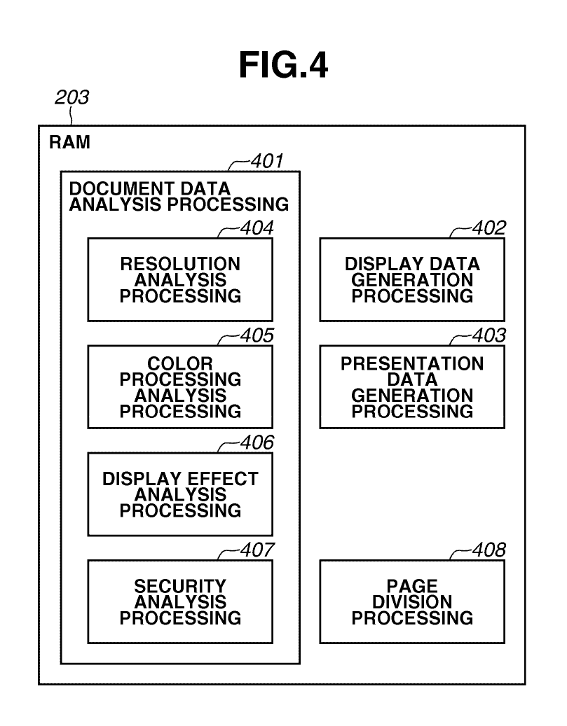

Referring to FIG. 2, a central processing unit (CPU) 201 is a controller in charge of the overall control of the printing apparatus 100. The CPU 201 activates an operating system (OS) through a boot program stored in a read-only memory (ROM) 202, and executes a controller program and various application programs stored in a mass storage 206, on the OS. The various application programs include processing modules illustrated in FIG. 4. The CPU 201 is connected to the respective units constituting the printing apparatus 100 through an internal bus 204 such as a data bus.

A random access memory (RAM) 203 serves as, for example, a main memory or a work area for the CPU 201, and is also used as a temporary storage area for image processing. An interface control unit 207 controls a network interface (I/F) such as a network interface card (NIC) 208, and transmits/receives various data such as image data to/from a network such as a LAN.

An operation interface (I/F) 210 inputs, for example, a command and data instructed from a user through an operation unit 211. The operation unit 211 is constituted by, for example, a touch panel and hard keys. Further, the operation I/F 210 also has the function of displaying an operation screen on the touch panel (i.e., the operation unit 211).

A printer image processing unit 212 generates bitmap data by applying image processing for a print output to data such as document data, and transmits the generated bitmap data to a printer unit 214 through a printer I/F 213. A rendering unit 215 converts document data into bitmap data (display data) so that the document data can be displayed by the projector 120 or can be printed out by the printer unit 214.

Document data transmitted from the PC 140 is input into the printing apparatus 100 via the LAN 150. The input document data is analyzed by the CPU 201 as to the object configuration including a text object and an image object, and then is transferred to the rendering unit 215. The rendering unit 215 generates bitmap data based on the object configuration including a text object and an image object analyzed by the CPU 201.

Bitmap data generated by the printer image processing unit 212 and the rendering unit 215 can be stored into a mass storage 206 by a storage control unit 205 so that it can be enlarged and displayed by the projector 120.

FIG. 4 is a conceptual diagram illustrating processing modules stored in the ROM 202 or the mass storage 206 of the printing apparatus 100. These processing modules are read out to the RAM 203 and executed by the CPU 201 as needed.

Document data analysis processing (module) 401 is a processing module for analyzing property of document data, i.e., analyzing objects contained in document data to determine display settings on the projector 120. The document data analysis processing 401 includes processing modules of resolution analysis processing 404, color processing analysis processing 405, display effect analysis processing 406, and security analysis processing 407.

Display data generation processing 402 is a processing module for reading out objects contained in document data, performing settings required for rendering, and generating display data by the rendering unit 215.

Presentation data generation processing 403 is a processing module for generating a control command for the projector 120 based on an analysis result of document data, and generating presentation data together with the control command to display data generated by the display data generation processing 402. Page division processing 408 is a processing module of analyzing document data to determine whether a page should be divided. These processing modules will be described in detail below.

<Projector>

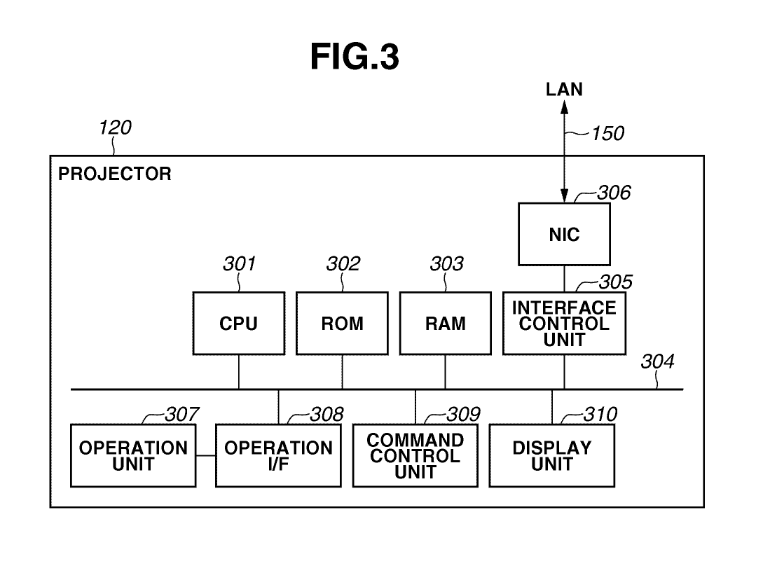

FIG. 3 is a block diagram schematically illustrating a configuration of the projector 120. In FIG. 3, a CPU 301 is a controller in charge of the overall control of the projector 120. The CPU 301 activates an operating system (OS) through a boot program stored in a ROM 302, and executes a controller program and various application programs on the OS.

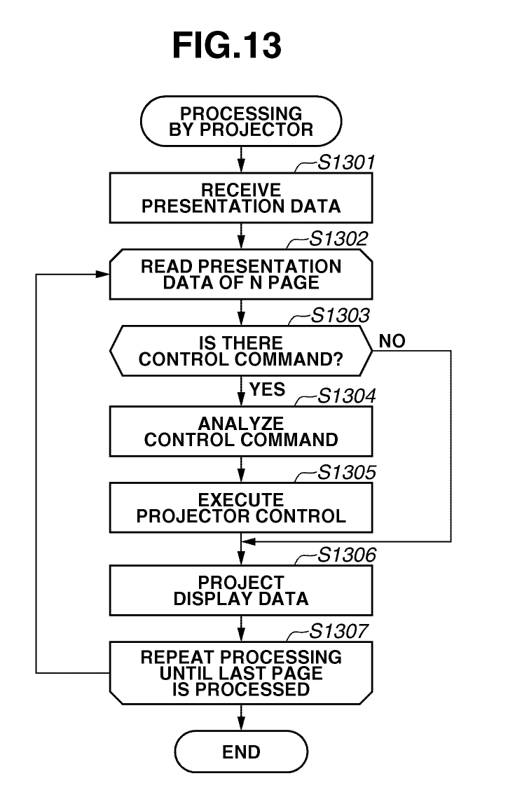

These various application programs include a program which realizes processing of the flowchart illustrated in FIG. 13. The CPU 301 is connected to the respective units constituting the projector 120 through an internal bus 304 such as a data bus.

The RAM 303 serves as, for example, a main memory or a work memory for the CPU 301, and is also used as a temporary storage area when image display processing is performed. Further, the RAM 303 also stores presentation data transmitted from the printing apparatuses 100 and 110.

An interface control unit 305 controls a network I/F such as a network interface card (NIC) 306, and transmits/receives various data such as image data to/from a network such as the LAN 150. An operation I/F 308 inputs a command and data instructed from a user through an operation unit 307. The operation unit 307 is constituted by, for example, a remote controller and hard keys. Further, the operation I/F 308 also has the function of displaying an operation screen onto the screen 130 by controlling a display unit 310.

A command control unit 309 interprets a received control command, and performs various display controls by the projector 120. The display unit 310 is constituted by, for example, a liquid crystal panel, and projects (enlarges) and displays presentation data onto the screen 130 under the control of the CPU 301.

<Presentation Data Generation and Transmission Processing>

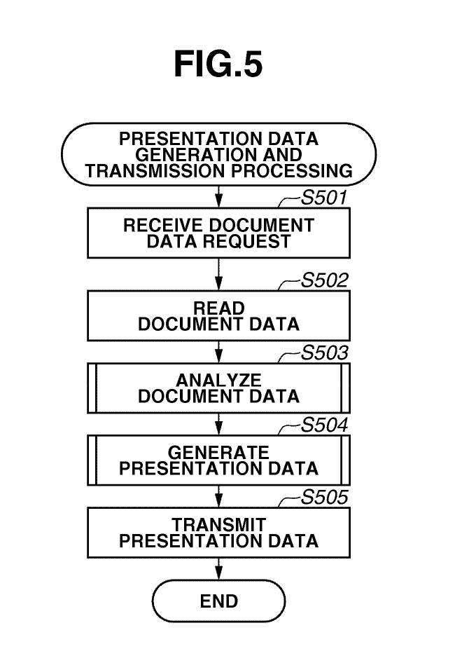

FIG. 5 is a flowchart illustrating presentation data generation and transmission processing according to the first exemplary embodiment, which is performed by the printing apparatuses 100 and 110.

In step S501, the CPU 201 receives a document data request command from the projector 120 through the LAN 150. This document data request command contains specification of document data which the projector 120 requests to enlarge and display. Then, in step S502, the CPU 201 reads out the document data specified by the document data request command from the mass storage 206.

Next, in step S503, the CPU analyzes the property of the read out document data. This document data property analysis processing will be described in detail below. In this property analysis processing, a control command for controlling an operation of the projector 120 is determined. In this case, the control command is selected and determined from control commands for the projector 120 which are stored in advance in, for example, the ROM 302.

Then, in step S504, the CPU 201 generates presentation data based on the result of the document data analysis. This presentation data generation processing will be described in detail below.

Next, in S505, the CPU 201 transmits the generated presentation data to the projector 120 through the interface control unit 207.

<Document Data Analysis Processing>

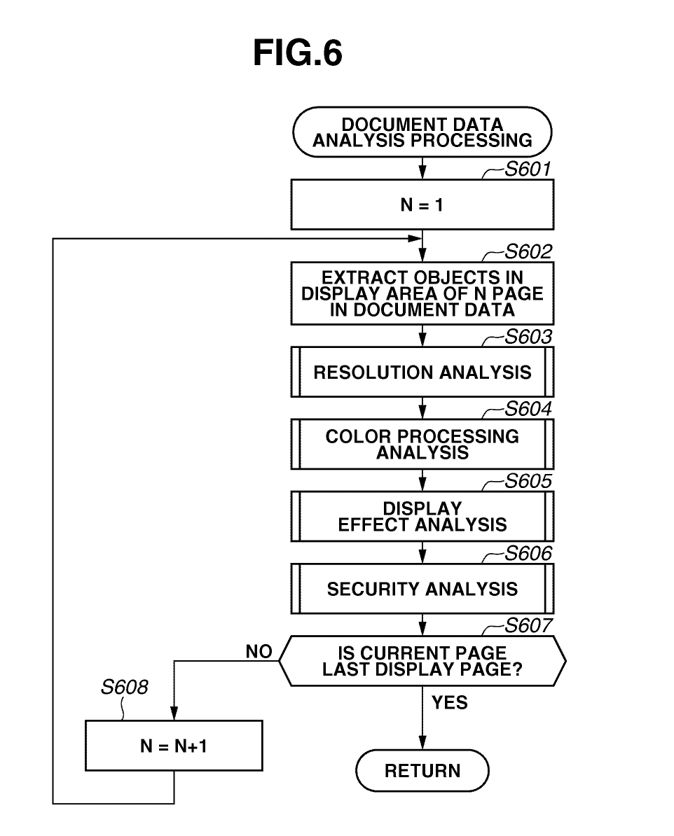

Next, the document data analysis processing performed in step S503 in FIG. 5 will be described in detail with reference to the flowchart of FIG. 6.

In step S601, the CPU 201 sets “1” to a variable N which indicates a page number in document data targeted for the analyses, i.e., document data requested by the projector 120. Next, in step S602, the CPU 201 extracts objects in a display area of a page indicated by the variable N (page N), i.e., objects constituting the substantial document data not including a margin part. Examples of these objects include a text object, a graphic object, and an image object.

In steps S603, S604, S605, and S606, the CPU 201 sequentially performs analysis processes of a resolution analysis, a color processing analysis, a display effect analysis, and a security analysis, according to the extracted objects in the display area. These analysis processes of the resolution analysis, the color processing analysis, the display effect analysis, and the security analysis are performed by executing the above-described processing modules of the resolution analysis processing 404, the color processing analysis processing 405, the display effect analysis processing 406, and the security analysis processing 407, respectively. These analysis processes will be described in detail below.

In step S607, the CPU 201 determines whether the analyzed page is the last page after performing the above-described analysis processes. If the analyzed page is not the last page (NO in step S607), the processing proceeds to step S608. In step 608, the CPU 201 increments the variable N by “1”. Then, the processing returns to S602, whereby the analysis processes of steps S603 to S606 are performed to all pages in the document data targeted for the analyses.

<Resolution Analysis Processing>

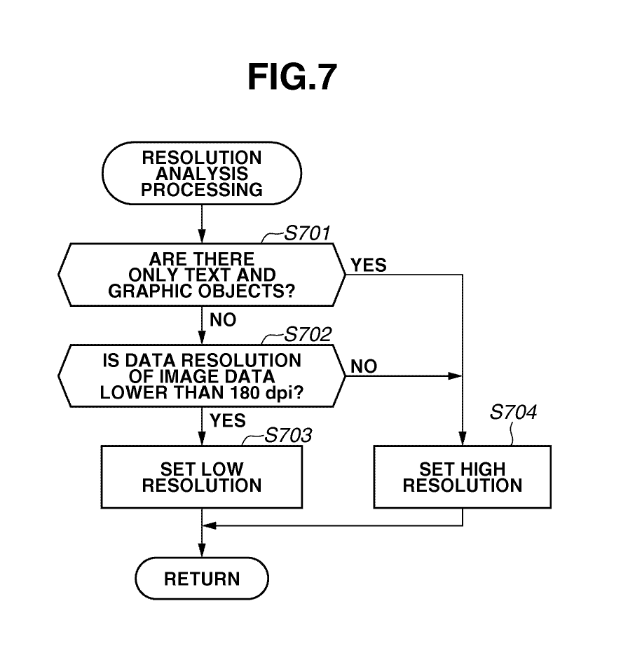

FIG. 7 is a flowchart illustrating details of the resolution analysis processing 404 performed in step S603 in FIG. 6.

In the resolution analysis processing 404, in step S701, the CPU 201 determines whether the page which is currently targeted for the analysis is constituted only by text objects and graphic objects, and contains no image object. As a result, if the page is constituted only by text objects and graphic objects, and contains no image objects (YES in step S701), the processing proceeds to step S704. In step S704, the CPU 201 sets “HIGH RESOLUTION” as the display setting based on the resolution analysis of this page.

On the other hand, if the page contains an image object (NO in step S701), the processing proceeds to step S702. In step S702, the CPU 201 determines whether the data resolution set to the image object is lower than 180 dpi. As a result, if the data resolution set to the image object is 180 dpi or higher (NO in step S702), the processing proceeds to S704. In step S704, the CPU 201 sets “HIGH RESOLUTION” as the display setting based on the resolution analysis of this page. If the data resolution set to the image object is lower than 180 dpi (YES in step S702), the processing proceeds to step S703. In step S703, the CPU 201 sets “LOW RESOLUTION” as the display setting based on the resolution analysis of this page.

<Color Processing Analysis>

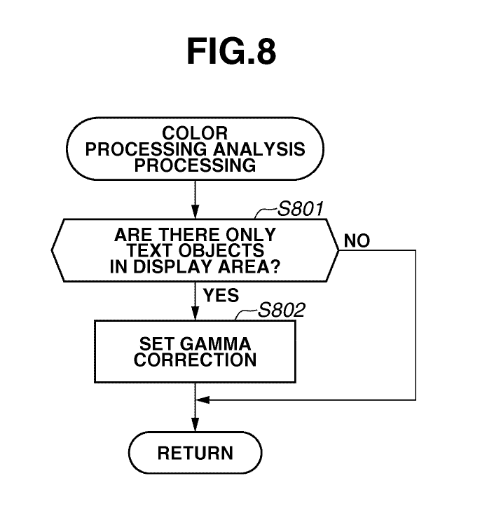

FIG. 8 is a flowchart illustrating details of the color processing analysis processing 405 performed in step S604 in FIG. 6. In the color processing analysis processing 405, in step S801, the CPU 201 determines whether there are only text objects in the objects extracted from the display area of the page which is currently targeted for the analysis.

If the CPU 201 determines that there are only text objects (YES in step S801), the processing proceeds to step S802. In step S802, the CPU 201 sets “GAMMA CORRECTION” as the display setting based on the color processing analysis of this page so that the texts can be clearly displayed. If the CPU 201 determines that there is an object which is not a text object (NO in step S801), nothing is set as the display setting based on the color processing analysis of this page.

<Display Effect Setting>

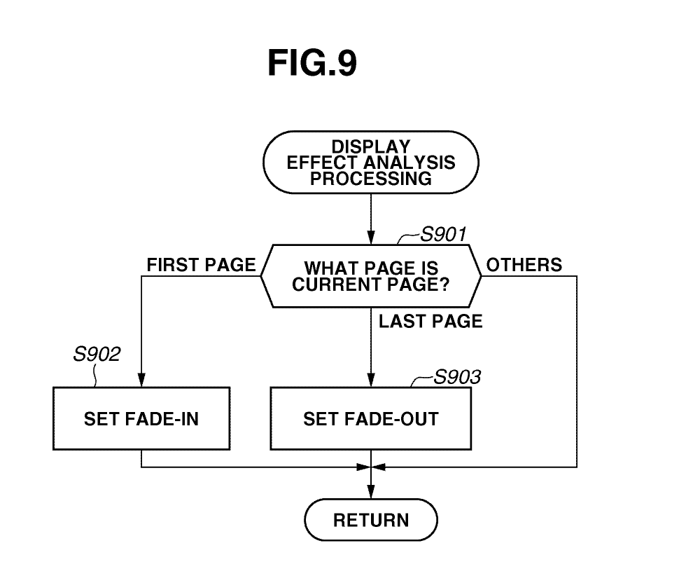

FIG. 9 is a flowchart illustrating details of the display effect analysis processing 406 performed in step S605 in FIG. 6. In the display effect analysis processing 406, in step S901, the CPU 201 determines what page in the analyzed document the page which is currently targeted for the analysis is. If the page targeted for the analysis is not the first page or the last page (OTHERS in step S901), the CPU 201 sets nothing to this page as the display setting based on the display effect analysis.

On the other hand, if the page targeted for the analysis is the first page (FIRST PAGE in step S901), the processing proceeds to step S902. In step S902, the CPU 201 sets “FADE IN” as the display setting based on the display effect analysis of this first page. If the page targeted for the analysis is the last page (LAST PAGE in step S901), the processing proceeds to step S903. In step S903, the CPU 201 sets “FADE OUT” as the display setting based on the display effect analysis of this last page.

<Security Analysis>

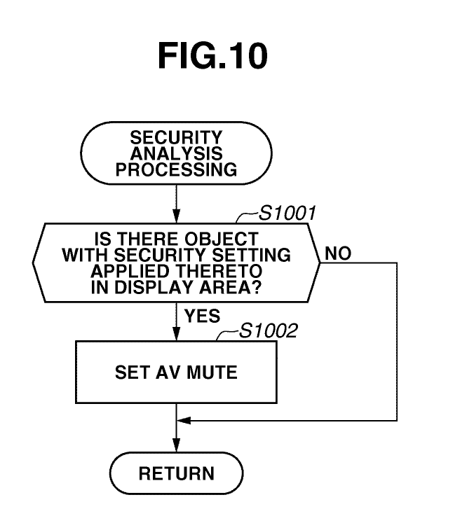

FIG. 10 is a flowchart illustrating details of the security analysis processing 407 executed in step S606 in FIG. 6. In the security analysis processing 407, in step S1001, the CPU 201 determines whether there is an object with a security setting applied thereto in the objects extracted from the display area of the page which is currently targeted for the analysis. More specifically, this determination processing is performed by, for example, determining whether there is an encrypted object or an object with a restriction regarding display/print set thereto.

If there is an object with a security setting applied thereto (YES in step S1001), the processing proceeds to step S1002. In step S1002, the CPU 201 sets “DISPLAY PROHIBITION” as the display setting based on the security analysis of this page. If there is no object with a security setting applied thereto (NO in step S1001), the CPU 201 sets nothing as the display setting based on the security analysis of this page.

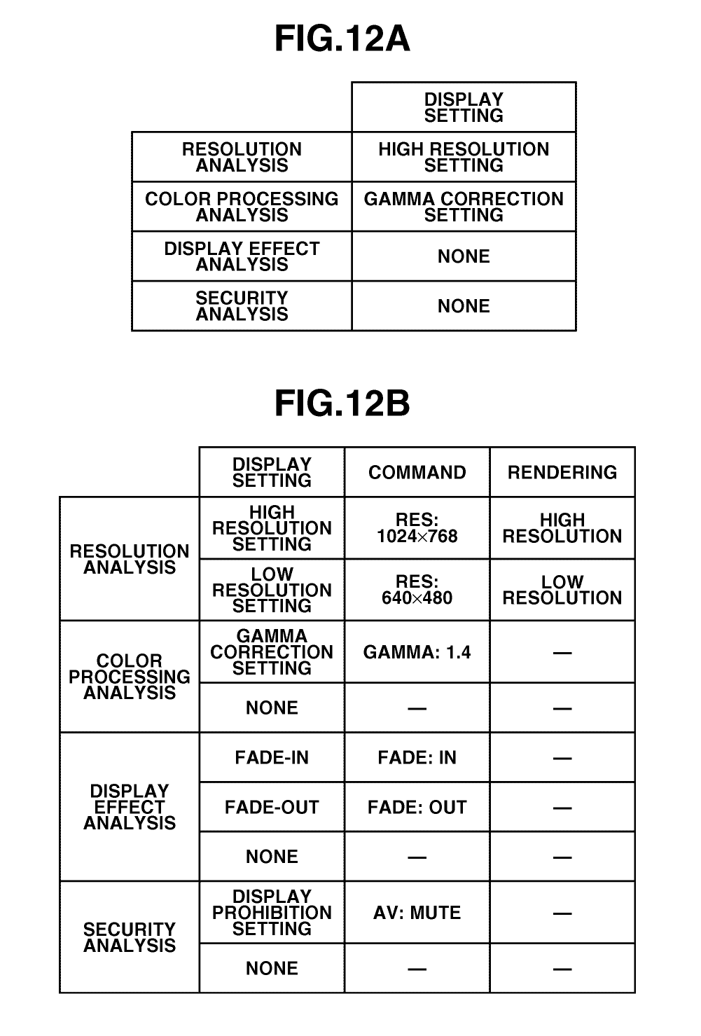

The CPU 201 executes, for each page in the document data, the document data analysis processing 401 constituted by the above-described resolution analysis processing 404, color processing analysis processing 405, display effect analysis processing 406, and security analysis processing 407. As a result, for example, the display settings based on the document data property analysis as illustrated in FIG. 12A are performed to a page. These display settings are performed, for example, on the RAM 203.

A correspondence table indicating the corresponding relationship between a control command for the projector 120 and a rendering mode, corresponding to the display setting as illustrated in FIG. 12B is recorded in any of the RAM 203, the ROM 202 (if the ROM 202 is a programmable ROM), and the mass storage 206.

<Presentation Data Generation Processing>

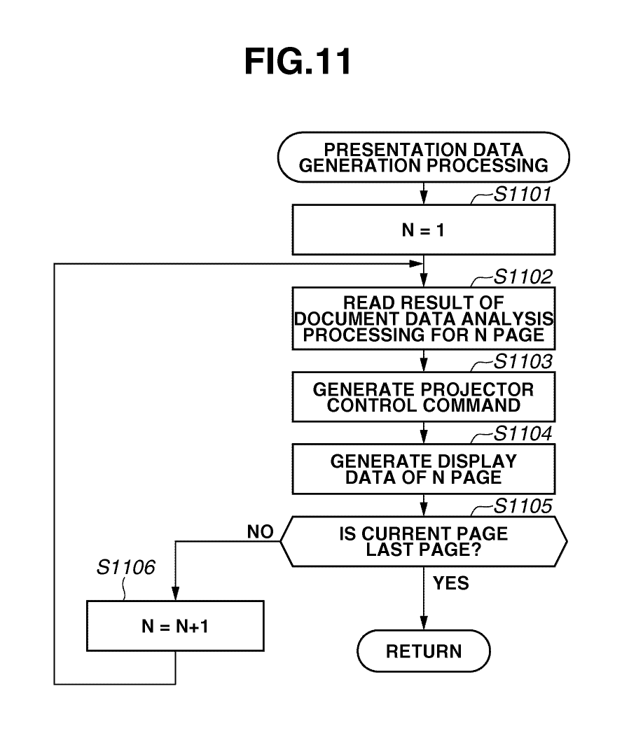

FIG. 11 is a flowchart illustrating the presentation data generation processing 403.

In step S1101, the CPU 201 sets “1” as an initial value to the variable N which indicates the page number of a page for which presentation data is generated. Next, in step S1102, the CPU 201 reads out, from the RAM 203, the result (display settings) of the document data property analysis processing of the page indicated by the variable N.

Then, in step S1103, the CPU 201 refers to the correspondence table of FIG. 12B, and reads out the control command (the command in the command field in FIG. 12B) corresponding to the analysis processing result to generate a control command for the projector 120 with respect to the current page.

Next, in step S1104, the CPU 201 refers to the correspondence table of FIG. 12B, and reads out information regarding the rendering mode corresponding to the result of the document data property analysis processing with respect to the current page to set it to the rendering unit 215 and generate display data of the current page.

Then, in step S1105, the CPU 201 determines whether the page indicated by the variable N is the last page. If the page is not the last page (NO in step S1105), the processing proceeds to step S1106. In step S1106, the CPU 201 increments the variable N by “1”. Then, the processing returns to step S1102, whereby all of the pages in the document data are processed by the processing constituted by steps S1102 to S1104.

<Presentation Data Processing by Projector>

FIG. 13 is a flowchart illustrating presentation data processing performed by the projector 120.

In step S1301, the CPU 301 of the projector 120 receives presentation data by the interface control unit 305 from the printing apparatus 100 or 110 through the LAN 150. In this case, the CPU 301 stores the presentation data received by the interface control unit 305 into the RAM 303.

Next, in step S1302, the CPU 301 reads the presentation data (a control command and display data) stored in the RAM 303 by one page at a time. This reading of the presentation data is started when the CPU 301 receives an instruction for a presentation start from the operation I/F 307.

Next, in step S1303, the CPU 301 determines whether the presentation data of the current page contains a control command. If the data contains a control command (YES in step S1303), the processing proceeds to step S1304. In step S1304, the CPU 301 analyzes this control command.

More specifically, this determination and analysis processing is performed by extracting a control command and a parameter for controlling the projector 120 from the presentation data of the current page. Then, in step S1305, the CPU 301 sets the extracted control command and parameter to the command control unit 309, and causes the unit 309 to execute the control of the projector 120.

As a result of this control, for example, if a brightness adjustment command and a parameter indicating brightness are extracted from the presentation data of the current page, the brightness when the document data of the current page is displayed on the screen 130 is adjusted according to the brightness indicated by the parameter.

Next, in step S1306, the CPU 301 transfers the display data of the current page to the display unit 310 to cause the display data to be projected onto the screen 130. In step S1307, the CPU 301 repeats the processing constituted by steps S1302 to 1306 until the last page of the presentation data is processed.

<Communication Between Printing Apparatus and Projector>

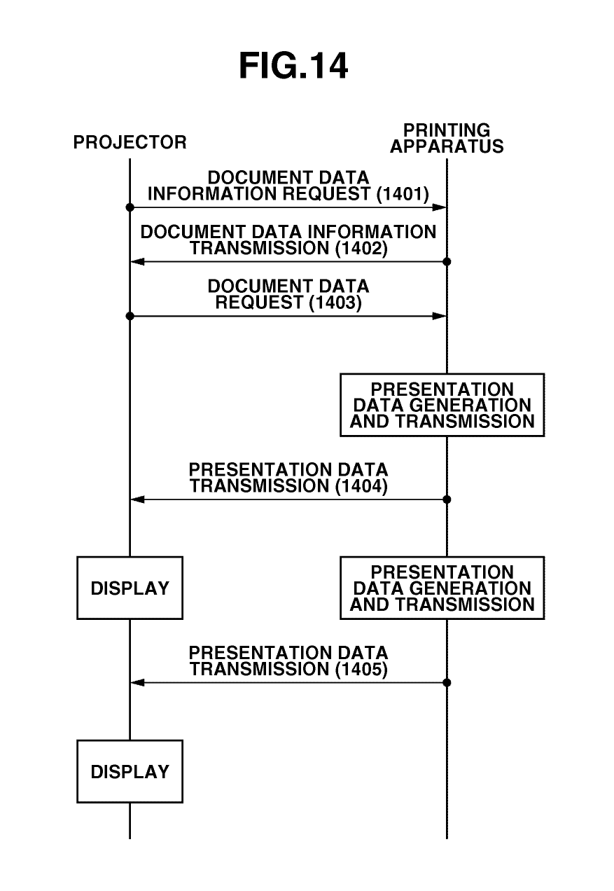

FIG. 14 is a sequence diagram illustrating communication between the printing apparatus 100 or 110, and the projector 120. As illustrated in FIG. 1, the printing apparatuses 100 and 110, and the projector 120 are connected via the LAN 150, and transmits/receives a command and data to/from each other.

In this case, first, the projector 120 performs a document data information request 1401 to the printing apparatus 100 or 110. More specifically, a user, who intends to make a presentation, requests document data information stored in the printing apparatus 100 or 110 by directly specifying a document file or searching a file by a keyword with use of a remote controller dedicated to the projector 120 or the operation unit 307 of the projector 120.

In other words, a user does not necessarily have to request a single document file. For example, a file list containing a plurality of document files corresponding to a keyword enables a user to request a plurality of document files at a time.

The printing apparatus 100 or 110 performs document data information transmission 1402 for transmitting a requested document file to the projector 120. More specifically, this document data information transmission 1402 includes transmission of a file name or a file list specified by a user.

The projector 120 displays a file name or a file list in the text format or thumbnail format on the operation screen on the display unit 310 of the projector 120 or the screen 130. Then, the user confirms this display content, and selects a document file which the user wants to display on the screen 130 by the projector 120, with use of a remote controller dedicated to the projector 120 or the operation unit 307.

The projector 120 performs a document data request 1403 for requesting the document file selected by the user to the printing apparatus 100 or 110.

Upon reception of the document data request 1403 from the projector 120, the printing apparatus 100 or 110 starts the presentation data generation and transmission processing for the requested document data as illustrated in FIG. 5.

Then, the printing apparatus 100 or 110 generates presentation data by combining the control command and display data, and performs presentation data transmission 1404 after generating presentation data corresponding to at least one page.

Upon reception of the presentation data, the projector 120 performs various settings according to the received control command by the command control unit 309, and projects the received display data onto the screen 130 by the display unit 310, as illustrated in FIG. 13.

The printing apparatus 100 or 110 sequentially transmits the presentation data of each of the pages in the requested document data to the projector 120. The projector 120 sequentially stores, in the RAM 203, the presentation data of each page transmitted from the printing apparatus 100 or 110. When an instruction for displaying the next page is issued through, for example, the operation unit 307, the CPU 301 reads out the presentation data of the next page from the RAM 303.

Then, the CPU 301 sets the control command in the read out presentation data to the command control unit 309, and causes the display data to be projected on the screen 130 by the display unit 310.

<Example of Document Data>

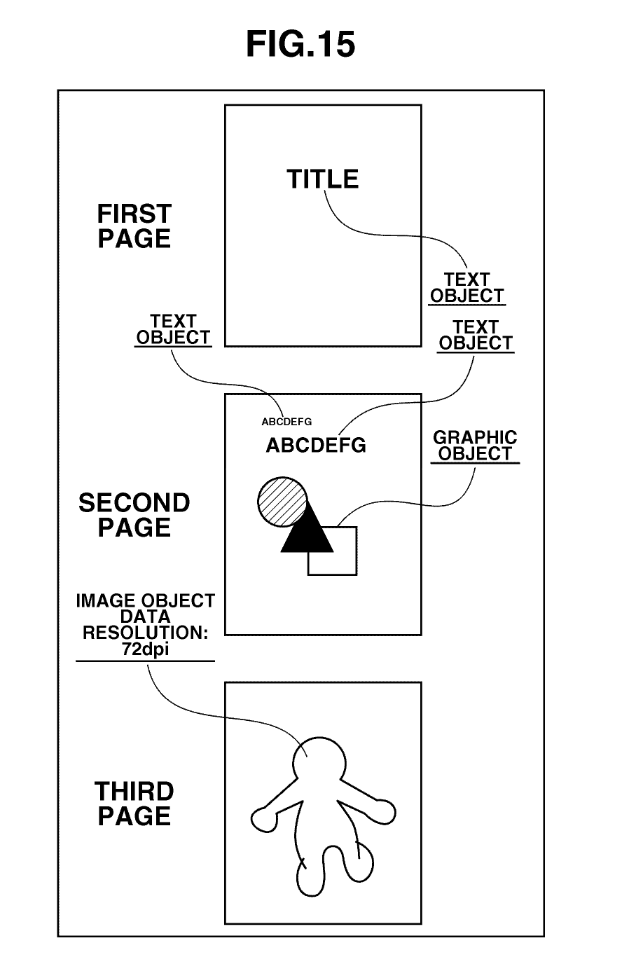

It is assumed that document data illustrated in FIG. 15 is stored in the mass storage 206 of the printing apparatus 100. In this case, when the document data illustrated in FIG. 15 is specified through the document data request 1403 from the projector 120, the printing apparatus 100 starts the presentation data generation and transmission processing with respect to this document data.

In this presentation data generation and transmission processing, it is determined that the objects constituting the first page are only text objects. Accordingly, in the resolution analysis processing 404, “HIGH RESOLUTION” is set as the display setting. Similarly, in the color processing analysis processing 405, “GAMMA CORRECTION” is set as the display setting, and in the display effect analysis processing 406, “FADE-IN” is set as the display setting because this page is the first page.

Further, it is determined that the objects constituting the second page are text objects and graphic objects. Accordingly, in the resolution analysis processing 404, “HIGH RESOLUTION” is set as the display setting. In the color processing analysis processing 405 and the display effect analysis processing 406, nothing is set as the display setting because this page is the second page.

Further, it is determined that the objects constituting the third page are only image objects. In addition, it is determined that the resolution of this image object is 72 dpi. Accordingly, in the resolution analysis processing 404, “LOW RESOLUTION” is set as the display setting, and in the color processing analysis processing 405, nothing is set as the display setting. In the display effect analysis processing 406, “FADE-OUT” is set as the display setting because this page is the last page.

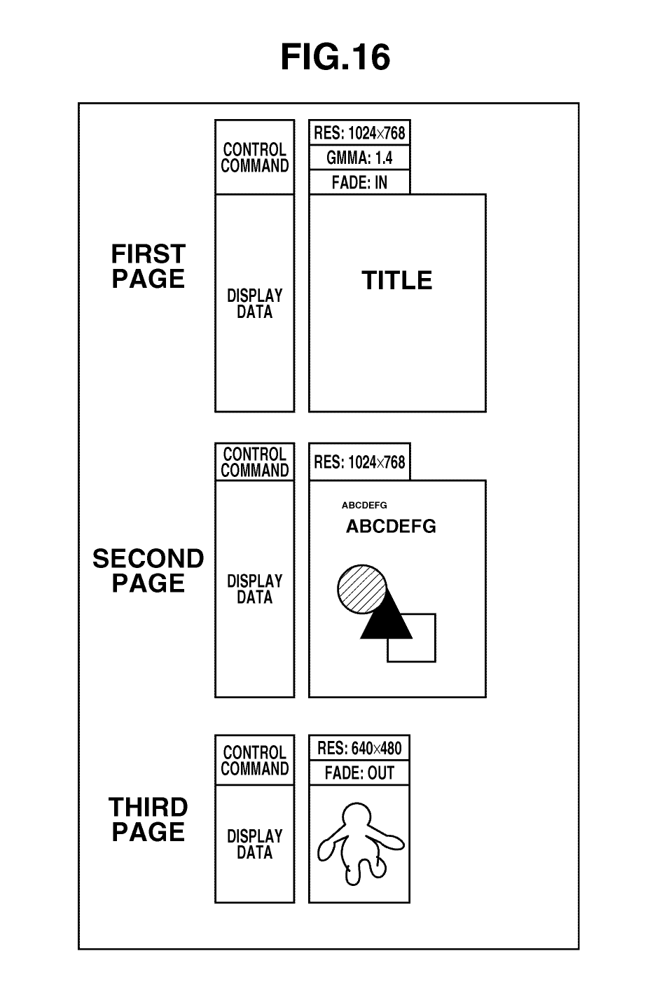

The above-described display settings result in generation of the presentation data constituted by the control command (s) and display data (bitmap data) as illustrated in FIG. 16.

In this way, in the first exemplary embodiment, for a page containing an image object like the third page, bitmap data is generated at low resolution if the resolution of the image object is low resolution. Therefore, it is possible to reduce the data size of display data, compared to generation of bitmap data at high resolution in the same manner for all pages.

Further, in the first exemplary embodiment, a display effect such as fade-in and fade-out is realized by using a control command, not by additionally generating display data like in the conventional method.

Therefore, it becomes possible to cut down the data size of display data (bitmap data), reduce the data transfer time to the projector 120, and enhance the response speed for a display.

In the first exemplary embodiment, the property of the document data stored in the printing apparatus 100 is analyzed page by page, and a control command for projector 120 and display data are generated page by page based on this analysis result.

On the other hand, the layout of the display area in a page in document data sometimes does not match the layout of the display screen of the projector 120, i.e., the layout of the screen 130. For example, when document data indicates a portrait (vertically long) display area, but the layout of the display screen of the projector 120 is landscape, projection of that document data by the projector 120 without any arrangement added thereto results in the display of a reduced portrait image.

Therefore, in the second exemplary embodiment, a display area of one page in document data is divided into display areas matching the display screen of the projector 120, and a control command for the projector 120 and display data are generated for each of the divided display areas.

<Presentation Data Generation and Transmission Processing Including Page Division Processing>

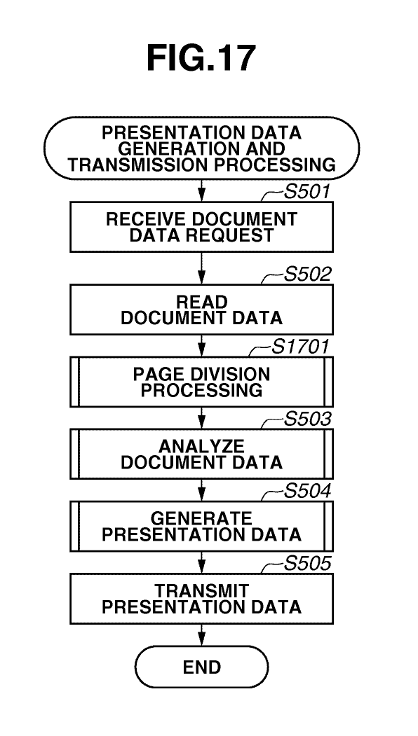

FIG. 17 is a flowchart illustrating presentation data generation and transmission processing according to the second exemplary embodiment, which is performed by the printing apparatus 100 or 110. A difference from the presentation data generation and transmission processing according to the first exemplary embodiment illustrated in FIG. 5 is only addition of page division processing in step S1701. Therefore, in the following, only the page division processing will be described. This page division processing in step S1701 is processing for dividing a display area of one page in document data into display areas matching the display screen of the projector 120, as mentioned above.

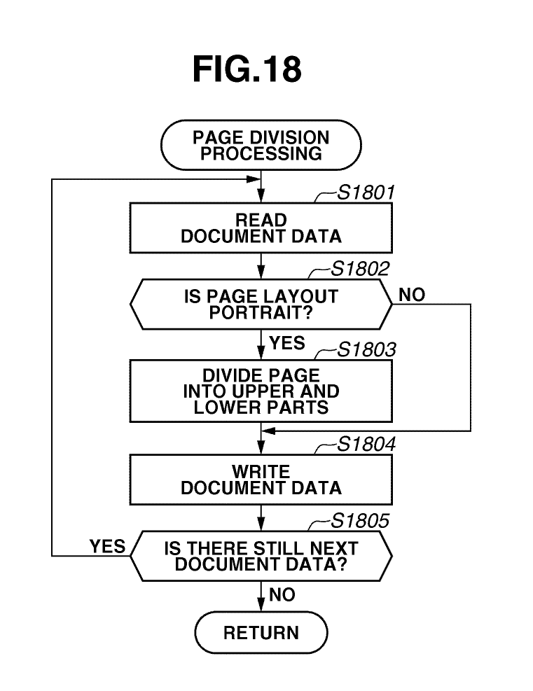

This page division processing is performed, following the steps in the flowchart illustrated in FIG. 18. The page division processing illustrated in FIG. 18 is performed, assuming that the display screen of the display unit 310 of the projector 120, and the display area of the screen 130 have a landscape layout.

In step S1801, the CPU 201 reads out into the RAM 203 document data corresponding to one page. Then, in step S1802, the CPU 201 determines whether the layout of the display area of the document data of the read page is portrait (vertically long) or landscape (horizontally long). More specifically, this determination processing is performed by analyzing the area of the objects constituting the page, or referring to information of “PORTRAIT” or “LANDSCAPE” specified as the layout of the page.

If the layout of the display area is portrait (YES in step S1802), the processing proceeds to step S1803. In step S1803, the CPU 201 modifies the document data stored in the RAM 203 so that the page is divided by the center line of the display area in the vertical direction. Then, in step S1804, the CPU 201 writes the document data stored in the RAM 203 into the mass storage 206.

On the other hand, if the layout of the display area is “LANDSCAPE” (NO in step S1802), the processing proceeds to step S1804. In step S1804, the CPU 201 writes the document data stored in the RAM 203 into the mass storage 206 without any modification made thereto. Next, in step S1805, the CPU 201 determines whether there is the next page in the document data. If there is the next page (YES in step S1805), the processing returns to step S1801, whereby the next page is read out and the same processing is performed.

In this way, even if a page in document data has a layout that does not match the projection display by the projector 120, division of that page enables the page to have a layout matching the projection display by the projector 120. After the page is divided, the document data property analysis is performed for each of the pages into which the original page is divided. Therefore, it becomes possible to more appropriately apply the resolution analysis processing, the color processing analysis processing, the display effect analysis processing, and the security analysis processing.

In the first and second exemplary embodiment, the control commands for controlling the projector 120 are prepared in advance in the printing apparatuses 100 and 110, and a control command is selected and determined from the prepared control commands based on the property of document data.

However, when there is a plurality of projectors, control commands capable of controlling the projectors may vary. One possible measure for handling this case is to prepare all control commands for the plurality of projectors in advance in the printing apparatuses 100 and 110. However, this measure is impractical in consideration of the limited memory capacity of the printing apparatuses 100 and 110. In addition, development of a projector controlled by a new control command in the future will make this measure useless.

Therefore, in a third exemplary embodiment, each projector stores control commands for itself, and the printing apparatuses 100 and 110 acquire those control commands from each projector in advance, and add a control command corresponding to each projector to display data.

<System Configuration of Third Exemplary Embodiment>

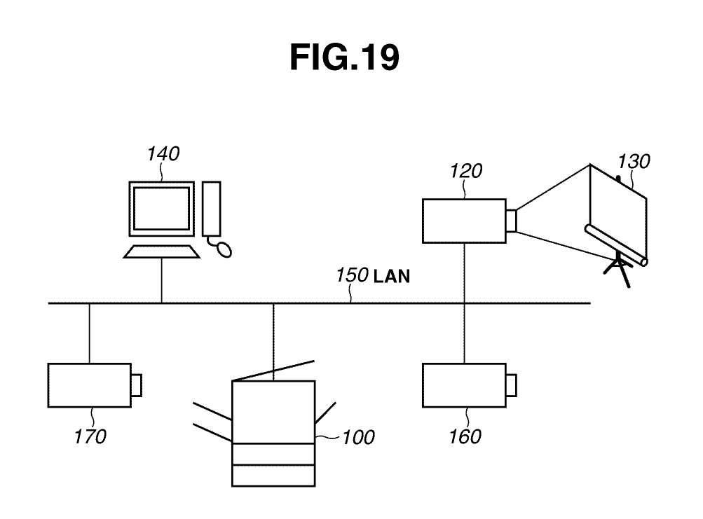

FIG. 19 schematically illustrates a configuration of a display system according to the third exemplary embodiment of the present invention. In the third exemplary embodiment, projectors 120, 160, and 170, which have different display performances, are connected to the LAN 150 along with the PC 140 and the printing apparatus 100.

<Acquirement of Control Command for Projector>

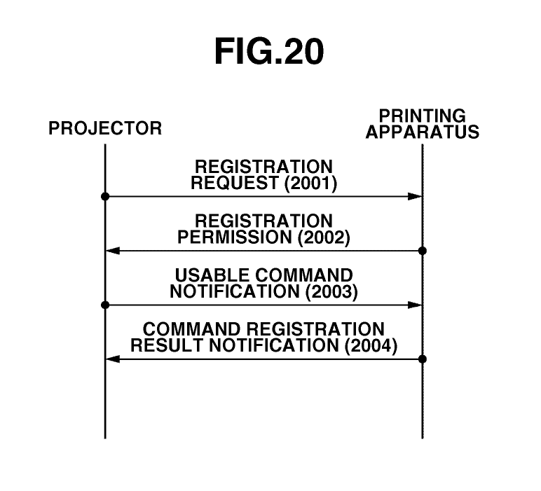

FIG. 20 is a sequence diagram illustrating communication between the printing apparatus 100, and the projector 120, 160, or 170. Through this communication, the printing apparatus 100 acquires control commands that can be used for each of the projectors 120, 160, and 170. The timing at which the control commands are acquired is not especially defined, but it is desirable to acquire the control commands for the projector before a user makes presentation, for example, when a user selects the printing apparatus 100 for searching for document data through the projector 120, 160, or 170.

Referring to FIG. 20, the projector 120, 160, or 170 transmits a registration request 2001 to the printing apparatus 100. The printing apparatus 100 transmits a registration permission 2002 to the projector 120, 160, or 170, provided that the RAM 203 or the mass storage 206 has a enough storage area to register information including the control commands of the projector 120, 160, or 170. This registration permission 2002 contains specification of a document analysis category with respect to the projector control required as the printing apparatus 100, and a required command request list.

Upon reception of the registration permission, the projector 120, 160, or 170 transmits, to the printing apparatus 100, a list of usable control commands corresponding to the document analysis category specified by the received registration permission 2002 as a usable command notification 2003.

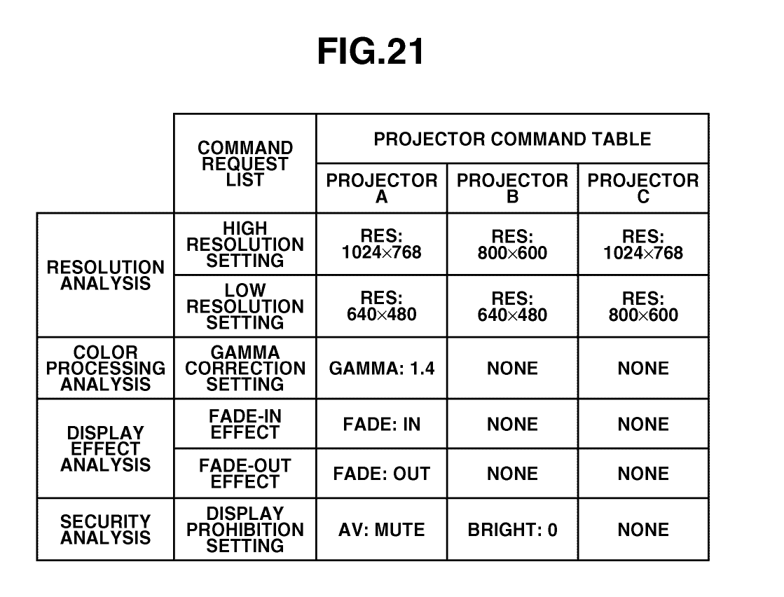

The printing apparatus 100 stores the received usable command notification 2003 in the RAM 203 or the mass storage 206 (refer to FIG. 21), and transmits a command registration result notification 2004 to the projector 120, 160, or 170.

In the high resolution setting illustrated in FIG. 21, the control commands for performing high resolution setting at the projectors 120, 160, and 170 are registered. In the low resolution setting, the control commands for performing low resolution setting at the projectors 120, 160, and 170 are registered.

Further, “NONE” is registered for a control command with respect to an analysis which a projector does not support. Further, like the display prohibition setting, a display effect may have different control commands registered depending on the projectors even for realizing the same display effect.

The printing apparatus 100 uses the command table for the projectors which is registered in the above-described sequence to determine a control command when the printing apparatus 100 generates presentation data.

In this way, the printing apparatus 100 acquires in advance control commands for a projector as a transmission destination to which presentation data is transmitted, whereby the printing apparatus 100 can transmit a control command usable to the projector, no matter what kind of control command the projector uses.

The present invention is not limited to the above-described first to third exemplary embodiments. For example, the image processing apparatus which controls a display of document data by the projector may be embodied by an image reading apparatus that is not a printing apparatus (multifunction peripheral (MFP)), or another apparatus such as a personal computer.

Further, the image processing apparatus which controls a display of document data by the projector, and the projector may be connected via any network that is not a LAN, such as a wide area network (WAN) (public line). Alternatively, they may be connected via a serial transmission medium such as a USB, or a parallel transmission medium such as Centronics or the small computer system interface (SCSI).

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-274370 filed Dec. 2, 2009, which is hereby incorporated by reference herein in its entirety.

What is claimed is:

1. A display system configured to display document data by a projector under control by an image processing apparatus, the image processing apparatus comprising:
an analysis unit configured to analyze a property of the document data;
a generation unit configured to generate display data for displaying the document data by the projector;
a determination unit configured to determine a control command for controlling the projector based on the property of the document data which is analyzed by the analysis unit; and
a transmission unit configured to transmit the display data generated by the generation unit, and the control command determined by the determination unit to the projector.

2. The display system according to claim 1, wherein the analysis unit analyzes resolution as the property.

3. The display system according to claim 1, wherein the analysis unit analyzes a display effect as the property.

4. The display system according to claim 1, wherein the analysis unit analyzes the property page by page.

5. The display system according to claim 1, further comprising a division unit configured to divide a page of the document data based on a layout of the document data and a layout of a display screen of the projector,
wherein the analysis unit analyzes the property for each of document data units into which the document data is divided by the division unit.

6. The display system according to claim 1, wherein the determination unit determines the control command by selecting a control command from control commands stored in advance in the image processing apparatus, according to the property of the document data which is analyzed by the analysis unit.

7. The display system according to claim 1, wherein the determination unit determines the control command by acquiring control commands for controlling the projector from the projector, and selecting a control command from the acquired control commands according to the property of the document data which is analyzed by the analysis unit.

8. An image processing apparatus having a function of controlling a display of document data by a projector, the image processing apparatus comprising:
an analysis unit configured to analyze a property of the document data;
a generation unit configured to generate display data for displaying the document data by the projector;
a determination unit configured to determine a control command for controlling the projector based on the property of the document data which is analyzed by the analysis unit; and
a transmission unit configured to transmit the display data generated by the generation unit and the control command determined by the determination unit to the projector.

9. A method for controlling an image processing apparatus having a function of controlling a display of document data by a projector, the method comprising:
analyzing a property of the document data;
generating display data for displaying the document data by the projector;
determining a control command for controlling the projector based on the property of the analyzed document data; and
transmitting the generated display data and the determined control command to the projector.

10. A computer-readable storage medium storing a program for causing a computer to execute the method for controlling the image processing apparatus according to claim 9.
